(19) United States
(12) Patent Application Publication
(10) Pub. No.: US 2025/0038364 A1
(43) Pub. Date: Jan. 30, 2025

(54) ALL-SOLID-STATE BATTERY

(71) Applicant: SAMSUNG ELECTRO-MECHANICS CO., LTD., Suwon-si, Gyeonggi-do (KR)

(72) Inventors: Taehoon KIM, Suwon-si, Gyeonggi-do (KR); Tae Gyeom LEE, Suwon-si, Gyeonggi-do (KR); Namgyu KIM, Suwon-si, Gyeonggi-do (KR); Myung Jin JUNG, Suwon-si, Gyeonggi-do (KR); Kyunglock KIM, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/282,649

(22) PCT Filed: Jun. 16, 2023
(86) PCT No.: PCT/KR2023/008380

§ 371 Date: Sep. 18, 2023

(30) Foreign Application Priority Data
Jan. 16, 2023 (KR) 10-2023-0006229

(51) Int. Cl. H01M 50/483; H01M 10/0562; H01M 10/0585; H01M 50/437

(52) U.S. Cl. CPC H01M 50/483; H01M 10/0562; H01M 10/0585; H01M 50/437; H01M 2300/0068

(57) ABSTRACT

An all-solid-state battery according to the present disclosure includes a stack including: a solid electrolyte layer, and a positive electrode layer and a negative electrode layer disposed with the solid electrolyte layer interposed therebetween; and a first packaging material layer and a second packaging material layer disposed with the stack interposed therebetween. The first packaging material layer or the second packaging material layer includes bentonite-based clay, and ceramic glass not including lithium.

### TECHNICAL FIELD

The present disclosure relates to an all-solid-state battery.

### BACKGROUND ART

Recently, devices using electricity as an energy source are increasing. As application fields using electricity such as smart phones, camcorders, laptop PCs, electric vehicles, and the like are expanding, interest in electrical storage devices using electrochemical devices is increasing. Among the various electrochemical devices, rechargeable lithium batteries, which are chargeable and dischargeable and have a high operation voltage and significantly high energy density, are drawing huge attention.

The rechargeable lithium batteries are manufactured by applying a material capable of intercalating and deintercalating lithium ions to positive and negative electrodes and then injecting a liquid electrolyte between the positive and negative electrodes, wherein electricity is generated or consumed through oxidation/reduction reactions according to the intercalation and deintercalation of the lithium ions at the positive and negative electrodes. These rechargeable lithium batteries should basically be stable within a battery-operating voltage range and have performance to transfer the ions at a sufficiently high speed.

When the liquid electrolyte such as a non-aqueous electrolyte is applied to these rechargeable lithium batteries, there are advantages of high discharge capacity and high energy density. However, the rechargeable lithium batteries have problems of hardly realizing a high voltage, leaking the electrolyte solution, and having a high risk of fire and explosion.

In order to solve the problems, a secondary all-solid-state battery using a solid electrolyte instead of the liquid electrolyte has been proposed as an alternative. Research on applying the all-solid-state battery to various fields is being conducted, and a demand for an all-solid-state battery having excellent insulating properties and moisture-proofing is also increasing.

### DISCLOSURE OF INVENTION

### Brief Description of Drawings

FIG. 1 is a perspective view schematically illustrating an all-solid-state battery according to an embodiment.

FIG. 2 is a cross-sectional view of an all-solid-state battery according to an embodiment.

FIG. 3 is a cross-sectional view of an all-solid-state battery according to an all-solid-state battery according to another embodiment.

FIG. 4 is a cross-sectional scanning electron microscope (SEM) photograph of ion-milled bentonite-based clay.

FIG. 5 is a graph evaluating cycle characteristics of the all-solid-state battery cell manufactured in Example 1.

FIG. 6 is a graph evaluating cycle characteristics of the all-solid-state battery cell manufactured in the comparative example.

### MODE FOR THE INVENTION

An embodiment provides an all-solid-state battery with improved reliability due to excellent insulating properties and moisture-proofing.

However, the object to be achieved by the embodiments is not limited to the above-mentioned object but may be variously expanded without departing from the technical spirit of the embodiments.

An all-solid-state battery according to an embodiment includes: a stack including a solid electrolyte layer, and a positive electrode layer and a negative electrode layer disposed with the solid electrolyte layer interposed therebetween; and a first packaging material layer and a second packaging material layer disposed with the stack interposed therebetween. The first packaging material layer or the second packaging material layer includes bentonite-based clay and ceramic glass not including lithium.

The bentonite-based clay may be included in an amount of 10 to 70 volume % based on a total volume of the first packaging material layer or the second packaging material layer.

An average particle size of the bentonite-based clay may be 1 μm to 5 μm.

The ceramic glass not including lithium may include silicon (Si) oxide, boron (B) oxide, sodium (Na) oxide, barium (Ba) oxide, zinc (Zn) oxide, aluminum (Al) oxide, or a combination thereof.

The ceramic glass that does not contain lithium may include SiO₂, B₂O₃, Na₂O, BaO₅, ZnO, Al₂O₃, or a combination thereof.

A glass transition temperature (Tg) of the ceramic glass not including lithium may be 440° C. to 480° C.

A volume ratio of the bentonite-based clay and the ceramic glass not including lithium may be 10:90 to 70:30.

The all-solid-state battery further includes a first margin layer disposed on the same plane as the positive electrode layer and a second margin layer disposed on the same plane as the negative electrode layer, and the first margin layer or the second margin layer may include the bentonite-based clay and the ceramic glass not including lithium.

The bentonite-based clay may be included in an amount of 10 to 70 volume % based on a total volume of the first margin layer or the second margin layer.

An average particle size of the bentonite-based clay of the first margin layer or the second margin layer may be 1 μm to 5 μm.

The ceramic glass not including lithium of the first margin layer or the second margin layer may include silicon (Si) oxide, boron (B) oxide, sodium (Na) oxide, barium (Ba) oxide, zinc (Zn) oxide, aluminum (Al) oxide, or a combination thereof.

The ceramic glass not including lithium of the first margin layer or the second margin layer may include SiO₂, B₂O₃, Na₂O, BaO₅, ZnO, Al₂O₃, or a combination thereof.

A glass transition temperature (T_{g}) of the ceramic glass not including lithium of the first margin layer or the second margin layer may be 440° C. to 480° C.

A volume ratio of the bentonite-based clay of the first margin layer or the second margin layer and the ceramic glass not including lithium of the first margin layer or the second margin layer may be 10:90 to 70:30.

An all-solid-state battery according to another embodiment includes: a stack including a plurality of solid electrolyte layers, and a plurality of positive electrode layers and negative electrode layers alternately disposed with the plurality of solid electrolyte layers interposed therebetween; a first packaging material layer and a second packaging material layer disposed with the stack interposed therebetween; and a first external electrode and a second external electrode disposed on one surface and the other surface of the stack and connected to the positive electrode layers and the negative electrode layers, respectively. The first packaging material layer or the second packaging material layer includes bentonite-based clay and ceramic glass not including lithium.

The all-solid-state battery may further include a plurality of margin layers respectively disposed on the same plane as the plurality of positive electrode layers and the plurality of negative electrode layers, wherein the margin layers include the bentonite-based clay and the ceramic glass not including lithium.

A capacity retention rate of the all-solid-state battery after 5 cycles may be greater than or equal to 70%.

An all-solid-state battery according to another embodiment includes: a stack including a solid electrolyte layer, and a positive electrode layer and a negative electrode layer disposed with the solid electrolyte layer interposed therebetween; a first margin layer disposed on the same plane as the positive electrode layer; a second margin layer disposed on the same plane as the negative electrode layer; a first packaging material layer and a second packaging material layer disposed with the stack interposed therebetween; and a first external electrode and a second external electrode disposed on one surface and the other surface of the stack and connected to the positive electrode layer and the negative electrode layer, respectively. The first margin layer or the second margin layer includes bentonite-based clay.

The first margin layer or the second margin layer may further include ceramic glass not including lithium.

The solid electrolyte layer may include a material different from the first packaging material layer and the second packaging material layer.

The all-solid-state battery according to an embodiment has improved reliability of the battery is improved due to excellent insulation characteristics and moisture-proofing.

However, the various advantageous advantages and effects of the present invention are not limited to the above, and will be more easily understood in the process of de-scribing specific embodiments of the present invention.

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction,” which corresponds to an L-axis direction in the drawing.

Hereinafter, various embodiments and modifications will be described in detail with reference to the drawings.

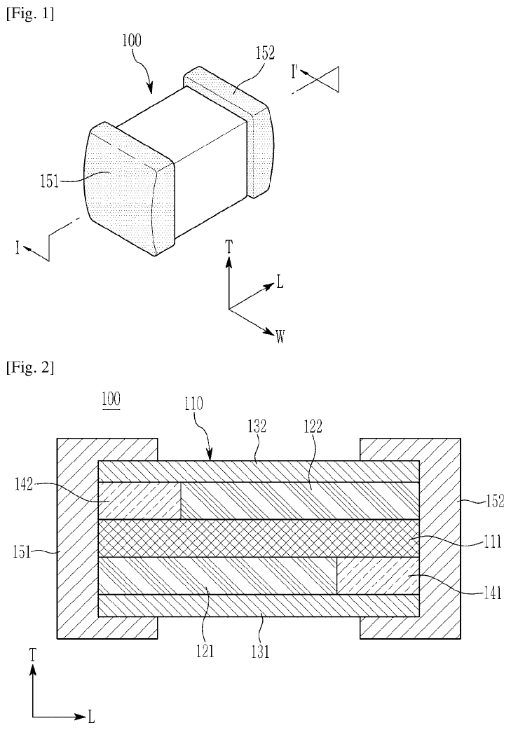

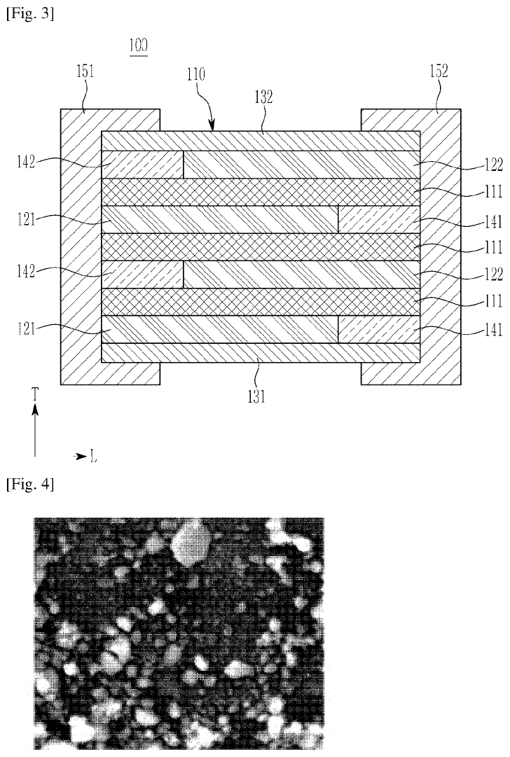

FIG. 1 is a perspective view schematically illustrating an all-solid-state battery according to an embodiment, FIG. 2 is a cross-sectional view of an all-solid-state battery according to an embodiment, and FIG. 3 is a cross-sectional view of an all-solid-state battery according to an all-solid-state battery according to another embodiment. Hereinafter, an all-solid-state battery will be described in detail with reference to FIGS. 1 to 3.

The all-solid-state battery 100 may have, for example, an approximate hexahedral shape.

The all-solid-state battery 100 according to an embodiment includes a stack 110 including a solid electrolyte layer 111, and a positive electrode layer 121 and a negative electrode layer 122 disposed with the solid electrolyte layer 111 interposed therebetween; and a first packaging material layer 131 and a second packaging material layer 132 disposed with the stack 110 interposed therebetween.

The first packaging material layer 131 or the second packaging material layer 132 includes bentonite-based clay and ceramic glass including not including lithium.

The all-solid-state battery 100 may further include a first margin layer 141 and a second margin layer 142 which are disposed on the same plane as the positive electrode layer 121 and the negative electrode layer 122.

The first margin layer 141 or the second margin layer 142 includes the bentonite-based clay and the ceramic glass not including lithium.

For example, the first packaging material layer, the second packaging material layer, the first margin layer, the second margin layer, or a combination thereof includes the bentonite-based clay and the ceramic glass not including lithium.

Or, the first packaging material layer and the second packaging material layer, or the first margin layer and the second margin layer include the bentonite-based clay and the ceramic glass not including lithium.

Otherwise, the first packaging material layer, the second packaging material layer, the first margin layer, and the second margin layer include the bentonite-based clay and include the ceramic glass not including lithium.

Herein, the bentonite-based clay and ceramic glass not including lithium included in the packaging material layers or the margin layers may be the same material. Hereinafter, the bentonite-based clay and the ceramic glass not including lithium included in the packaging material layers or the margin layers will be described in more detail.

FIG. 4 is a cross-sectional scanning electron microscope (SEM) photograph of ion-milled bentonite-based clay. Referring to FIG. 4, the bentonite-based clay, a clay mineral formed through a sedimentary rock action in which volcanic ash is compacted with seawater and recrystallized, is composed of nano-level microparticles and has excellent cation exchange adsorption properties. In particular, the bentonite-based clay has excellent moisture absorption and may be swollen up to 12 times of the original volume at maximum. This bentonite-based clay may be included in the packaging material layers or the margin layers to prevent intrusion of external moisture and the like and also physical and chemical impacts from the outside, realizing an all-solid-state battery having an excellent moisture-proof function.

Types of the bentonite-based clay include, for example, Na-type bentonite containing a large amount of Nations, Ca-type bentonite containing a large amount of Ca²⁺ ions, artificially activated bentonite from the Ca-type bentonite into the Na-type one by adding several wt % of sodium carbonate to the Ca-type bentonite, and the like.

The bentonite-based clay may have an average particle size of 1 μm to 5 μm, for example, 1 μm to 3 μm, or 1 μm to 2.5 μm. When the bentonite-based clay has an average particle size within the ranges, particles may be uniformly dispersed, ef-fcctively exhibiting the moisture-proof function.

The bentonite-based clay may be included in 10 volume % to 70 volume % based on a total volume of the first packaging material layer or the second packaging material layer, for example, 20 volume % to 60 volume %, or 40 volume % to 60 volume %.

The bentonite-based clay may be included in 10 volume % to 70 volume %, for example, 20 volume % to 60 volume %, or 40 volume % to 60 volume % based on a total volume of the first margin layer or the second margin layer.

When the bentonite-based clay is included within the volume ranges, the excellent moisture proof function may be realized without deteriorating mechanical properties of the packaging material layers or the margin layers.

In the packaging material layers or the margin layers, an insulating material used in the art may be further included to impart an additional insulating function. Examples of the insulating material may include alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanite (BaTiO₃), zirconium dioxide (ZrO₂), a mixture thereof, an oxide and/or nitride of these materials, or any other suitable ceramic material, but are not limited thereto.

The ceramic glass not including lithium (Li) has low ionic conductivity and low electron conductivity and prevent leakage of ions and electrons in the all-solid-state battery to prevent capacity deterioration of the battery.

The ceramic glass not including lithium may include silicon (Si) oxide, boron (B) oxide, sodium (Na) oxide, barium (Ba) oxide, zinc (Zn) oxide, aluminum (Al) oxide, or a combination thereof.

The ceramic glass not including lithium may include SiO₂, B₂O₃, Na₂O, BaO₅, ZnO, Al₂O₃, or a combination thereof.

A glass transition temperature (T_{g}) of the ceramic glass not including lithium may be 440° C. to 480° C. When the ceramic glass not including lithium has a glass transition temperature (T_{g}) within the range, since the glass transition temperature (T_{g}) is similar to a baking temperature of the solid electrolyte, interior and exterior materials of the all-solid-state battery have a similar baking temperature and shrinkage during the baking process, preventing thermal deformation.

The ceramic glass not including lithium may be included in 30 volume % to 70 volume %, for example, 30 volume % to 60 volume % based on the total volume of the first packaging material layer or the second packaging material layer.

When the ceramic glass not including lithium is included in less than 30 volume % based on the total amount of the first packaging material layer or the second packaging material layer, the all-solid-state battery may hardly maintain its shape, and when included in greater than 70 volume %, there is a disadvantage of deteriorating the moisture-proof effect.

The bentonite-based clay and the ceramic glass not including lithium may be included in a volume ratio of 10:90 to 70:30. When the bentonite-based clay is included excessively in a large amount, the all-solid-state battery may hardly maintain its shape, and there is a disadvantage of deteriorating the moisture-proof effect.

In an embodiment, the solid electrolyte layer 111 may include an inorganic solid electrolyte including an oxide-based solid electrolyte, a sulfide-based solid electrolyte, or a combination thereof.

The oxide-based solid electrolyte may be a garnet-type, a NASICON-type, a LISICON-type, a perovskite-type, a LiPON-type, or an amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ(PO₄)₃(0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃(0<x<1) such as Li_{1.3}Al_{0.3}Ti_{1.7}(PO₄)₃ introduced with excess lithium and/or lithium-zirconium-phosphate (LZP) of LiZr₂(PO₄)₃.

In addition, the LISICON-based solid electrolyte may be include a solid solution oxide represented by xLi₃AO₄-(1−x) Li₄BO₄ (A: P, As, V and B: Si, Ge, Ti) such as Li₄Zn(GeO₄)₄, Li₁₋₀GeP₂O₁₂ (LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄ (M: Si, Ge and M′ is P, Al, Zn, Ga) such as Li₃S—P₂S₅, Li₂S—SiS₂, Li₂S—SiS₂—P₂S₅, or Li₂S—GeS₂.

The perovskite-based solid electrolyte may include lithium lanthanum titanate (LLTO) represented by Li₃ₓLa_{2/3-x}□_{1/3-2x}TiO₃ (0<x<0.16□: vacancy) such as Li_{1/8}La_{5/8} TiO₃. The LiPON-based solid electrolyte may include a lithium phosphorous oxynitride such as Li_{2.8}PO_{3.3}N_{0.46}.

The amorphous electrolyte may include Li₂O—B₂O₃—SiO₂ (LBSO), Li₂O—B₂O₃—P₂O₅, Li₃BO₃—Li₂SO₄, or Li₃BO₃—Li₂CO₃.

The sulfide-based solid electrolyte may include a sulfur atom among electrolyte components and is not limited to a specific component, and may include one or more of a crystalline solid electrolyte, an amorphous solid electrolyte (glassy solid electrolyte), or a glass ceramic solid electrolyte.

For example, the sulfide-based solid electrolyte may include an LPS-type sulfide containing sulfur and phosphorus (e.g., Li₂S—P₂S₅), or a thio-LISICON-based compound Li₄₋ₓGe₁₋ₓPₓS₄ (x is 0.1 to 2, or x is ¾, or ⅔), Li_{10±1}MP₂X₁₂ (M is Ge, Si, Sn, or Al and X is S or Se), Li_{3.833}Sn_{0.833}AS_{0.166}S₄, Li₄SnS₄, Li_{3.25}Ge_{0.25}P_{0.75}S₄, Li₂S—P₂S₅, B₂S₃—Li₂S, xLi₂S-100-xP₂S₅ (x is 70 to 80), Li₂S—SiS₂—Li₃N, Li₂S—P₂S₅—LiI, Li₂S—SiS₂—LiI, Li₂S—B₂S₃—LiI, Li₁₀SnP₂S₁₂, or Li_{3.25}GC_{0.25}P_{0.75}S₄.

The solid electrolyte may have ionic conductivity of greater than or equal to 1λ10⁻³ S/cm. The ionic conductivity may be measured at a temperature of 25° C. The ionic conductivity may be greater than or equal to 1λ10⁻³ S/cm, 2λ10⁻³ S/cm, greater than or equal to 3λ10⁻³ S/cm, greater than or equal to 4λ10⁻³ S/cm, or greater than or equal to 5λ10⁻³ S/cm, of which an upper limit is not particularly limited. When a solid electrolyte satisfying the ranges of ionic conductivity is used, the all-solid-state battery 100 may exhibit high output.

In an embodiment, the positive electrode layer 121 of the all-solid-state battery 100 may include a positive active material and a conductive material. In an embodiment, the positive electrode layer 121 of the all-solid-state battery may be an integrated positive electrode layer 121 in which a positive electrode active material and a conductive material are mixed and disposed.

The positive electrode active material may include for example compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiaNi_{1-b-c}Co_{b}M_{c}Dₐ (wherein 0.90≤a≤1.8, 0≤b≤0.5, 0≤c≤0.05, 0≤a≤2): LiₐNi_{1-b-c}CO_{b}M_{c}O₂₋ₐXₐ (wherein 0.90≤a≤1.8, 0≤b≤0.5, 0≤c≤0.05, 0≤a≤2); LiₐNi_{1-b-c} Co_{b}M_{c}O₂₋ₐX₂ (wherein 0.90≤a≤1.8, 0≤b≤0.5, 0≤c≤0.05, 0≤a≤2); Liₐ Ni_{1-b-c}Mn_{b}M_{c}Dₐ (wherein 0.90≤a≤1.8, 0≤b≤0.5, 0≤c≤0.05, 0≤a≤2); Liₐ Ni_{1-b-c} Mn_{b}M_{c}O₂₋ₐXₐ (wherein 0.90≤a≤1.8, 0≤b≤0.5, 0≤c≤0.05, 0≤a≤2); LiₐNi_{1-b-c}Mn_{b}M_{c}O₂₋ₐX₂ (wherein 0.90≤a≤1.8, 0≤b≤0.5, 0≤c≤0.05, 0≤a≤2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GₑO₂ (wherein, 0.90≤a≤1.8, 0≤b≤0.9, 0≤c≤0.5, 0≤d≤0.5, 0.001≤e≤0.1); LiₐNiG_{b}O₂ (wherein 0.90≤a≤1.8, 0.001≤b≤0.1); LiₐCoG_{b}O₂ (wherein 0.90≤a≤1.8, 0.001≤b≤0.1); LiₐMnG_{b} O₂ (wherein 0.90≤a≤1.8, 0.001<b≤0.1); LiₐMn₂G_{b}O₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)} J₂(PO₄)₃(0≤f≤2); Li_{3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓ MnₓO₂ₓ (wherein 0<x<1), LiNi_{1-x-y}Coₓ Mn_{y}O₂ (wherein 0≤x≤0.5, 0≤y≤0.5). LiFePO₄, TiS₂, FeS₂, TiS₃, or FeS₃, but is not limited thereto.

The conductive agent is not particularly limited as long as it has conductivity without causing chemical change in the all-solid-state battery 100. Examples of the conductive agent may include: graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal components such as lithium (Li), tin (Sn), aluminum (Al), nickel (Ni), copper (Cu), and the like; oxides, nitrides, or fluorides thereof; conductive whiskers such as zinc oxide and potassium titanate; conductive metal oxides such as titanium oxide; or conductive materials such as polyphenylene derivatives.

In an embodiment, the positive electrode layer 121 of the all-solid-state battery may further include a solid electrolyte component. The solid electrolyte component may use one or more of the above components, and may function as an ion conduction channel in the positive electrode layer. Through this, the interfacial resistance may be reduced.

A method of forming the positive electrode layer 121 is not particularly limited but may include, for example, preparing a slurry by mixing the positive active material, a conductive material (additionally including a solid electrolyte layer, if necessary), a binder, and the like, coating this slurry on a separate support, and curing it to form the positive electrode layer 121.

In an embodiment, the negative electrode layer 122 of the all-solid-state battery 100 may include a negative electrode active material and a conductive material. In one embodiment, the negative electrode layer 122 of the all-solid-state battery may be an integrated negative electrode layer 122 in which a negative electrode active material and a conductive material are mixed and disposed.

The negative electrode layer may include a commonly used negative electrode active material. The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline-earth metal, Group 13 to 16 elements, a transition metal, a transition metal oxide such as lithium titanium oxide (Li₄Ti₅O₁₂), a rare earth element, or a combination thereof, and Sn is not included), or MₙOₓ (0<x≤2). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or mixtures thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophasc pitch carbonization product, calcined cokc, graphene, carbon black, fullerene soot, a carbon nanotube, a carbon fiber, and the like, but is not limited thereto.

The silicon may be selected from Si, SiOₓ (0<x<2, for example 0.5 to 1.5), Sn, SnO₂, a silicon-containing metal alloy, and a mixture thereof. The silicon-containing metal alloy may include, for example, silicon and one or more of Al, Sn, Ag, Fe, Bi, Mg, Zn, In, Ge, Pb, and Ti.

In an embodiment, the negative electrode layer 122 of the all-solid-state battery 100 may use the same conductive material as in the positive electrode layer 121. The negative electrode layer 122 may be manufactured according to almost the same method except that the negative electrode active material is used instead of the positive electrode active material in the above-described manufacturing process of the positive electrode.

Referring to FIG. 3, an all-solid-state battery 100 according to another embodiment includes a stack 100 including a plurality of solid electrolyte layers 111, and a plurality of positive electrode layers 121 and negative electrode layers 122 alternately disposed with the plurality of solid electrolyte layers 111 interposed therebetween; a first packaging material layer 131 and a second packaging material layer 132 disposed with the stack interposed therebetween; and a first external electrode 151 and a second external electrode 152 disposed on one surface and the other surface of the stack 110 and connected to the positive electrode layers 121 and the negative electrode layers 122, respectively. The first packaging material layer 131 or the second packaging material layer 132 includes bentonite-based clay and ceramic glass not including lithium.

The all-solid-state battery may further include a plurality of margin layers 141 and 142 disposed on the same plane as the plurality of positive electrode layers 121 and the plurality of negative electrode layers 122.

The margin layers 141 and 142 may include the bentonite-based clay and the ceramic glass not including lithium.

The first external electrode 151 and the second external electrode 152 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

The glass may have a composition in which oxides are mixed. The glass may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fc), and nickel (Ni), the alkali metal may be selected from lithium (Li), sodium (Na), and potassium (K), and the alkaline-earth metal may be selected from magnesium (Mg), calcium (Ca), strontium (Sr), and barium (Ba).

A method of forming the first external electrode and the second external electrode is not particularly limited. For example, the method may include dipping the cell stack in a conductive paste including a conductive metal and glass or screen-printing or gravure-printing the conductive paste on the surface of the cell stack.

In addition, various methods of applying the conductive paste on the surface of the cell stack or transferring a dry film obtained by drying the conductive paste onto the cell stack may be used.

The all-solid-state battery according to an embodiment has excellent insulating properties and moisture-proofing function, and thus exhibits a capacity retention rate of 70% or more after 5 cycles. Accordingly, the all-solid-state battery may exhibit excellent reliability.

Hereinafter, specific embodiments of the invention are presented. However, the embodiments described below are intended to specifically illustrate or explain the invention, and the scope of the invention should not be limited thereto.

### Example 1

A positive active material of LiCoO₂ (LCO) and a solid electrolyte of Li₂O—B₂O₃—SiO₂ (hereinafter, LBSO) are mixed in a volume ratio of 5:5 and then screen-printed, forming a 12 μm-thick positive electrode layer. A negative electrode active material of 2 μm graphite and a solid electrolyte of LBSO are mixed in a volume ratio of 5:5 and then screen-printed, forming an 8 μm-thick negative electrode layer. LBSO of the solid electrolyte is molded to form a 25 μm-thick solid electrolyte layer. 50 volume % of 2 μm bentonite-based clay and 50 volume % of ceramic glass not including lithium, SiO₂—B₂O₃—Na₂O—BaO₅—ZnO—Al₂O₃, are mixed, forming first and second packaging material layers. Each layer prepared above is stacked as shown in FIG. 2, manufacturing an all-solid-state battery cell.

### Example 2

An all-solid-state battery cell is manufactured in the same manner as in Example 1 except that the first margin layer and the second margin layer are formed in the same configuration as the first and second packaging material layers.

### Comparative Example

An all-solid-state battery cell is manufactured in the same manner as in Example 1 except that the first packaging material layer and the second packaging material layer are made into 20 sheets having 100 volume % of LBSO of the solid electrolyte.

### [Experimental Example] (Evaluation of Cycle Characteristics)

The all-solid-state battery cells according to Examples 1 and 2 and the comparative example are evaluated with respect to cycle characteristics as follows.

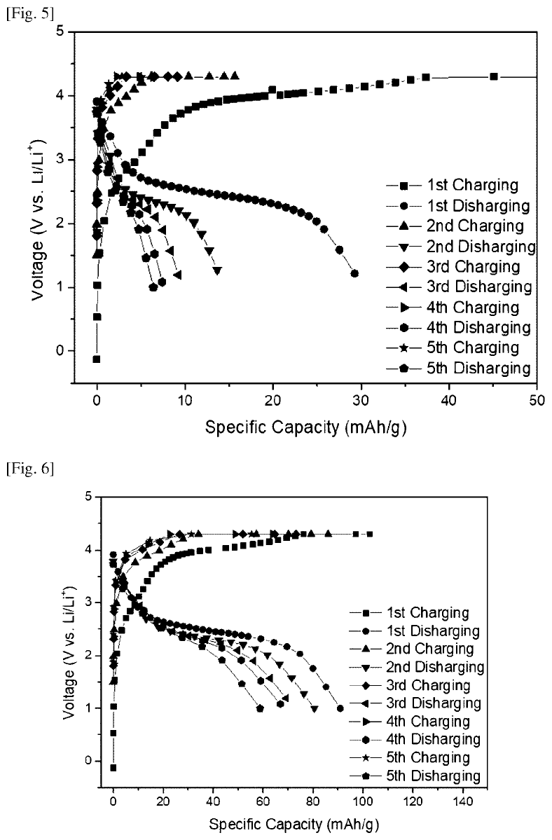

The all-solid-state battery cells, under conditions of 90 wt % and 60° C., are charged to a maximum voltage of 4.3 V at a constant current of 0.5 C and discharged to a cut-off voltage of 1.0 V at 0.5 C, and this charge and discharge cycle is repeated 5 times. Then, a ratio of discharge capacity at the 5^{th} cycle to discharge capacity at the 1^{st} cycle is obtained as a capacity retention rate. The capacity retention rate is a parameter exhibiting cycle characteristics, wherein the larger the capacity retention rate, the more excellent the cycle characteristics. The cycle characteristic results of the examples and the comparative example are shown in FIGS. 5 and 6.

Referring to FIG. 5 (Example 1), since bentonite-based clay and ceramic glass not including lithium are included in the first packaging material layer and the second packaging material layer, capacity after 5 cycles may maintain 70% of the initial capacity, which confirms very excellent cycle reliability characteristics of the battery cell.

In addition, even when bentonite-based clay and ceramic glass not including lithium are included all in the first packaging material layer, the second packaging material layer, the first margin layer, and the second margin layer, the capacity after the 5 cycles may maintain 70% of the initial capacity, which confirms very excellent cycle reliability characteristics of the battery cell.

Referring to FIG. 6 (Comparative Example), since bentonite-based clay and ceramic glass not including lithium are not included in the packaging material layers, cycle reliability characteristics of the battery cell are very insufficient.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to an all-solid-state battery having excellent insulating properties and a moisture-proofing function and thus improved reliability, which may be used for various electrochemical devices and electronic devices.

### DESCRIPTION OF SYMBOLS

100: all-solid-state battery
110: stack
111: solid electrolyte layer
121: positive electrode layer
122: negative electrode layer
131: first packaging material layer
132: second packaging material layer
141: first margin layer
142: second margin layer
151: first external electrode
152: second external electrode

The invention claimed is:

1. An all-solid-state battery, comprising:
a stack including a solid electrolyte layer, and a positive electrode layer and a negative electrode layer disposed with the solid electrolyte layer interposed therebetween; and
a first packaging material layer and a second packaging material layer disposed with the stack interposed therebetween,
wherein the first packaging material layer or the second packaging material layer includes bentonite-based clay, and ceramic glass not including lithium.

2. The all-solid-state battery of claim 1, wherein
the bentonite-based clay is included in an amount of 10 to 70 volume % based on a total volume of the first packaging material layer or the second packaging material layer.

3. The all-solid-state battery of claim 1, wherein
an average particle size of the bentonite-based clay is 1 μm to 5 μm.

4. The all-solid-state battery of claim 1, wherein
the ceramic glass not including lithium includes silicon (Si) oxide, boron (B) oxide, sodium (Na) oxide, barium (Ba) oxide, zinc (Zn) oxide, aluminum (Al) oxide, or a combination thereof.

5. The all-solid-state battery of claim 1, wherein
the ceramic glass not including lithium includes SiO₂, B₂O₃, Na₂O, BaO₅, ZnO, Al₂O₃, or a combination thereof.

6. The all-solid-state battery of claim 1, wherein
a glass transition temperature (T_{g}) of the ceramic glass not including lithium is 440° C. to 480° C.

7. The all-solid-state battery of claim 1, wherein
a volume ratio of the bentonite-based clay and the ceramic glass not including lithium is 10:90 to 70:30.

8. The all-solid-state battery of claim 1, wherein
the all-solid-state battery further includes a first margin layer disposed on the same plane as the positive electrode layer and a second margin layer disposed on the same plane as the negative electrode layer,
wherein the first margin layer or the second margin layer includes the bentonite-based clay, and the ceramic glass not including lithium.

9. The all-solid-state battery of claim 8, wherein
the bentonite-based clay is included in an amount of 10 to 70 volume % based on a total volume of the first margin layer or the second margin layer.

10. The all-solid-state battery of claim 8, wherein
an average particle size of the bentonite-based clay of the first margin layer or the second margin layer is 1 μm to 5 μm.

11. The all-solid-state battery of claim 8, wherein
the ceramic glass not including lithium of the first margin layer or the second margin layer includes silicon (Si) oxide, boron (B) oxide, sodium (Na) oxide, barium (Ba) oxide, zinc (Zn) oxide, aluminum (Al) oxide, or a combination thereof.

12. The all-solid-state battery of claim 8, wherein
the ceramic glass not including lithium of the first margin layer or the second margin layer includes SiO₂, B₂O₃, Na₂O, BaO₅, ZnO, Al₂O₃, or a combination thereof.

13. The all-solid-state battery of claim 8, wherein
a glass transition temperature (T_{g}) of the ceramic glass not including lithium of the first margin layer or the second margin layer is 440° C. to 480° C.

14. The all-solid-state battery of claim 8, wherein
a volume ratio of the bentonite-based clay of the first margin layer or the second margin layer and the ceramic glass not including lithium of the first margin layer or the second margin layer is 10:90 to 70:30.

15. The all-solid-state battery of claim 1, wherein
a capacity retention rate of the all-solid-state battery after 5 cycles is greater than or equal to 70%.

16. An all-solid-state battery, comprising:
a stack including a plurality of solid electrolyte layers, and a plurality of positive electrode layers and negative electrode layers alternately disposed with the plurality of solid electrolyte layers interposed therebetween;
a first packaging material layer and a second packaging material layer disposed with the stack interposed therebetween; and
a first external electrode and a second external electrode disposed on one surface and the other surface of the stack and connected to the positive electrode layers and the negative electrode layers, respectively,
wherein the first packaging material layer or the second packaging material layer includes bentonite-based clay, and ceramic glass not including lithium.

17. The all-solid-state battery of claim 16, wherein
the all-solid-state battery further includes a plurality of margin layers respectively disposed on the same plane as the plurality of positive electrode layers and the plurality of negative electrode layers, and the margin layers include the bentonite-based clay and the ceramic glass not including lithium.

18. The all-solid-state battery of claim 16, wherein
a capacity retention rate of the all-solid-state battery after 5 cycles is greater than or equal to 70%.

19. An all-solid-state battery, comprising:
a stack including a solid electrolyte layer, and a positive electrode layer and a negative electrode layer disposed with the solid electrolyte layer interposed therebetween;
a first margin layer disposed on the same plane as the positive electrode layer;
a second margin layer disposed on the same plane as the negative electrode layer;
a first packaging material layer and a second packaging material layer disposed with the stack interposed therebetween; and
a first external electrode and a second external electrode disposed on one surface and the other surface of the stack and connected to the positive electrode layer and the negative electrode layer, respectively, wherein the first margin layer or the second margin layer includes bentonite-based clay.

20. The all-solid-state battery of claim 19, wherein
the bentonite-based clay is included in an amount of 10 to 70 volume % based on a total volume of the first margin layer or the second margin layer.

21. The all-solid-state battery of claim 19, wherein
an average particle size of the bentonite-based clay is 1 μm to 5 μm.

22. The all-solid-state battery of claim 19, wherein
the first margin layer or the second margin layer further includes ceramic glass not including lithium.

23. The all-solid-state battery of claim 22, wherein
the ceramic glass not including lithium includes silicon (Si) oxide, boron (B) oxide, sodium (Na) oxide, barium (Ba) oxide, zinc (Zn) oxide, aluminum (Al) oxide, or a combination thereof.

24. The all-solid-state battery of claim 22, wherein
the ceramic glass not including lithium includes SiO₂, B₂O₃, Na₂O, BaO₅, ZnO, Al₂O₃, or a combination thereof.

25. The all-solid-state battery of claim 22, wherein
a glass transition temperature (T) of the ceramic glass not including lithium is 440° C. to 480° C.

26. The all-solid-state battery of claim 22, wherein
a volume ratio of the bentonite-based clay and the ceramic glass not including lithium is 10:90 to 70:30.

27. The all-solid-state battery of claim 19, wherein
the solid electrolyte layer includes a material different from the first packaging material layer and the second packaging material layer.
